(19) United States
(12) Patent Application Publication
(10) Pub. No.: US 2013/0006920 A1
(43) Pub. Date: Jan. 3, 2013

(54) RECORD OPERATION MODE SETTING

(75) Inventor: Jack Kreindler, Greater London (GB)

(73) Assignee: GENIEDS ,INC., San Juan Capistrano, CA (US)

(21) Appl. No.: 13/512,877

(22) PCT Filed: Dec. 15, 2010
(86) PCT No.: PCT/IB2010/055838

§ 371 Date: May 30, 2012

(30) Foreign Application Priority Data
Dec. 15, 2009 (GB) 0921851.2

(51) Int. Cl. G06F 17/30

(52) U.S. Cl. 707/609; 707/E17.005

(57) ABSTRACT

Designers and implementers of distributed databases have to make difficult trade-offs between reliability, throughput, latency, ease of use, ease of administration and the quality of service provided to applications. Choosing these trade-offs is particularly difficult, as different applications often have widely varying requirements, meaning that different distributed database systems tend to specialise in particular types of application. A method is presented for architecting a distributed database in such a way that applications can make their needs known within fine-grained scopes (e.g., an individual database operation), and the database system can then use this information to alter the trade-offs it makes, thereby improving the quality of service experienced by the application, users, and administrators.

There are many different ways to structure a distributed database. For example:
Streaming Master/Slave replication involves all update operations being sent to a master server, which maintains a master copy of the database that is updated in real time, as well as a log of recent updates. Slave databases read the log from the master, and apply the changes to their own local copies of the database. Clients can then read records from the master or from any slave. This means that the master is a single point of failure, reads from slaves may return outdated information, and the master's ability to service client update and read requests while also streaming the log events to the slaves is a potential performance bottleneck.
Multi-master replication involves a number of servers, each of which has a copy of the database. Clients can issue read and update operations to any server; some means exists of the servers sharing their updates with each other, but the updates may now be seen in different orders by different servers, so mechanisms have to exist for ensuring that a consistent global state is reached, rather than the servers' states diverging without bounds. This means there is no single point of failure, but reads from different servers may return differing results in different orders, and the ability of the slowest server to perform the updates being issued to the system is a potential performance bottleneck.
Partitioning involves a number of servers, each of which has a fraction of the database (generally, a specific subset of the records goes to each server, but it is also possible to partition a table by columns). Each record exists on precisely one server. Reads and updates to that record have to be routed to the appropriate server for that record. There must be mechanisms to deduce what server is responsible for a record, sometimes when little about the record is known (a query might ask for all customers whose birthday it is today, for example), or queries have to be sent to every server in the system to ask them to search locally for any matching records. This means that there is no single point of failure for the system as a whole, but the loss of any one server means that a corresponding fraction of the database is lost (possibly permanently). Performance for random single-record reads and updates improves linearly as the number of servers increases, as there are more servers for the load to be spread across—but for any one record, all access have to be handled by one server, so the capacity of one server is still a potential performance bottleneck if access is concentrated onto particular records. Adding and removing servers while the system is running can require moving records as the partitioning scheme changes to allow for the additional server, which can reduce performance during the migration process.
Replication with a consistency buffer, as described in UK Patent Application 0920644.2 (System for Improved Record Consistency and Availability), consists of performing multi-master replication, while having a partitioned volatile short-term “consistency buffer” that is used to hold the new state of recently-updated records, while the state of that record across the servers is in flux as replication to the servers occurs in the background, thereby ensuring that a consistent view of the database is available, while providing the performance and availability benefits of multi-master replication. This means that the failure of a consistency server can create temporary visibility of old versions of records that would have been handled by the consistency server, that reads and updates have a slightly higher latency due to the requirement to contact consistency servers and wait for their responses, and that if access is concentrated upon particular records, the throughput limits of the consistency servers for those records are a potential performance bottleneck, but otherwise, the performance characteristics are as per multi-master replication.
Partitioning with master/slave replication involves partitioning the database into a number of partitions, as with ordinary partitioning, and assigning responsibility for each record to a server; but each record also has a number of slave servers assigned to it (which may or may not also be master servers for other records, etc). These slave servers are also updated, either by the master server forwarding updates to them or directly by the client at the same time as the master is updated. Reads are often serviced only from the master server for that record in order to avoid the consistency consequences of replication lag, with a slave server being promoted to become a master if the corresponding master server fails, so the performance benefits of replication are not realised. Such systems typically perform like partitioned systems, with some update throughput and latency costs due to the replication, but with the ability to recover from server failures.
Partitioning with multi-master replication involves partitioning the database, as with ordinary partitioning, by assigning responsibility for each record to a subset of the available servers, which form a multi-master replication system for that record. This may be done by assigning records to partitions, then assigning partitions to sets of servers, meaning that each server within a partition will carry the same records; or Individually directly assigning each record to a set of servers, such that each server will carry a generally different set of records. This offers a compromise between a full multi-master replicated system and a fully partitioned system; the read throughput and latency benefits of replication can be traded off with the write throughput benefits of partitioning, at the cost of the consequent consistency issues of replication. It also introduces a new trade-off to consider: how many replicas to make of each record? This parameter is usually hard-coded into the system as a whole, or perhaps configurable per-table.
Partitioning with multi-master replication and a consistency buffer is similar to the previous technique, but with the consistency buffer removing the consistency issues of the replication in exchange for some increased latency.
For comparison, no distribution at all means that there is a single server, carrying every record. That server handles all reads and updates. This means there is a single authoritative current state of every record, but as if the server fails, all of the data is lost, potentially permanently; and the throughput limits of that server are a potential performance bottleneck.

Even this brief survey of high-level architectures for distributed systems shows a wide variety of implementation techniques, with correspondingly widely varying characteristics. Combining partitioning with multi-master replication provides an application-controllable trade-off between the characteristics of a fully-replicated multi-master system and a purely partitioned system, and potentially does so on a fine-grained scale (the decision of how widely to replicate a record can be made per table, or even per record). However, implementing a consistency buffer is an architectural-level design decision that forces a trade-off upon the application—a consistent view of replicated data, in exchange for increased latency. And every implementation technique leads on to many finer-grained decisions as the details are elaborated.

For a start, a key problem in a replicated database is preventing conflicts. Database rules such as uniqueness constraints may state that two updates may be individually legal, but the combination of the two is illegal. If two such conflicting updates are issued at once in different parts of the system, then as the updates are replicated through the system, they will eventually meet each other and the conflict will be detected—but then which of the two should be allowed to proceed?

One method of solving this is to require that every update be performed in two phases. In the first phase, the update is proposed to every server that should carry a replica of the record being updated. Each server checks for conflicts with the state it already holds. If there would be a conflict, it returns a refusal, otherwise it “reserves” the proposed update, so that any future proposals that would conflict with it are rejected while the reservation holds, and returns an acceptance. If all connected servers accept the update, then the client can initiate the second phase, of asking the servers to “commit the reservation” and actually make the update so it is visible to readers; if any refuse, then the reservation Is withdrawn. This ensures that conflicting updates may never occur, but at a great cost in update latency and overall system resource consumption to process an update.

In a replicated database, It is possible to reduce update latency considerably by reporting an update as complete as soon as the update is known to other servers, even if only in volatile memory, rather than having to wait for it to be committed to non-volatile storage; if the chances of a system failure affecting multiple servers is acceptably low, then it is fair to consider the update as being “safe” as soon as it is known to other servers. However, some or all updates may be considered sufficiently vital that the update should not be considered complete until a specified number of servers have confirmed that it is written to disk, which can increase the update latency even further.

Typically, the implementer of a distributed database picks the approach they feel will best meet the needs of their future customer, and implements it. SQL is the de-facto standard for applications to access a database system, but the field is rife with non-standard extensions to SQL that provide highly useful functionality, such as system-issued primary keys for new records, full-text searching, advanced data types such as geometric objects, and performance tuning of queries, so portability of applications between databases is rare; and there is growing movement away from using SQL due to access patterns of many applications favouring an object-based model rather than a relational one, and limitations of the SQL query model. Even if an SQL interface is provided, the update consistency semantics of different distributed data storage systems vary, meaning that applications which rely on certain behaviour may not work across databases.

The developer of an application that wishes to use a distributed database must choose a database product that provides the best characteristics for the most important operations performed by the application, or to use more than one database product, and then have to bear the burden of having different parts of the data in incompatible systems, meaning that database query features such as JOINs cannot be used; or that some parts of the system may be placed within databases that do not offer ideal characteristics for that type of data.

Even for a given data item, it may be desirable to have different characteristics for different operations; a daily snapshot of the state of a database for backup purposes or for off-line analysis can tolerate slightly outdated versions of some records in exchange for minimising the impact on the system as a whole and maximum throughput of that one operation, for example, while very different criteria may hold for access to the same data by the public-facing e-commerce web site.

Therefore there is a desire within the industry for a means of providing varied distributed storage semantics within the context of a single overall database system, ideally on a per-operation basis where applicable.

### SUMMARY OF THE INVENTION

An aspect of the present invention provides a record storage system comprising two or more data stores, each data store comprising a record set that is substantially a replica of the record set stored by the or each other data store, a data store being designated as a primary data store to each record, and each record having record characteristics including a unique record identity, and a first client configured to, in response to receiving a record update request comprising at least one write instruction, a data record identity identifying the data record on which the write instruction is to be performed, and a set of at least one or more mode indicators, request an operation on the identified record according to a record operation protocol, the record operation protocol being determined by the at least one mode indicator each time a record update request is received.

### DESCRIPTION OF THE DRAWINGS

The present invention will now be described by way of example with reference to the accompanying drawing, in which:

FIG. 1 shows a typical aspect of the records storage system of the present invention.

### DETAILED DESCRIPTION

This invention is a method of implementing a distributed database system that allows different models of access to the data to co-exist. The method as described operates within a database system using some degree of replication, which may be full replication, or replication combined with partitioning in some way, and providing consistent views of that replicated system with a consistency buffer as described in UK Patent Application 0920644.2 (System for Improved Record Consistency and Availability), and using the technique described in UK Patent Application 0920645.9 (A Method for Using Information About Application—Level Structural Access Patterns to Optimise Access to a Database).

The aforementioned patents, taken together, describe a combined method for reading and updating records, where an update consists of providing a new value for a record identified by a given primary key. If the new value for the record is a special sentinel value representing a deleted record, then the update deletes the record, if it exists. If a record with that primary key does not previously exist in the table, then this update creates the record. Otherwise, an existing record is updated to a new state.

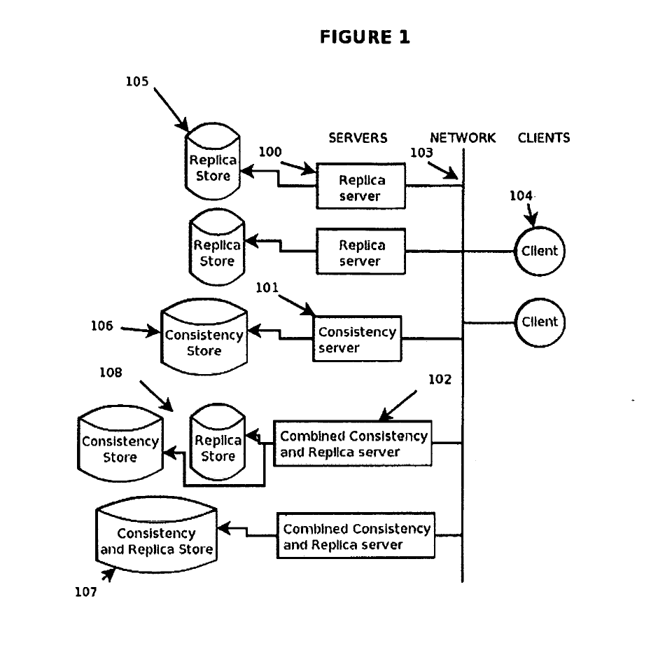

In an aspect of the invention shown in FIG. 1, the record storage system comprises:

1. A set of one or more replica servers (100) with replica storage (105).

2. A potentially overlapping, disjoint, or identical set of one or more consistency servers (101) with consistency storage (106), configured to store the most recent versions of records.

3. A client application, running on one of the above servers or on some separate computer (104) configured to update or read records, or find records matching some criteria.

4. A network or other communications medium joining the above servers (103).

Given that a record, identified by a primary key K, from a table named T, to be replicated to a set S of N servers S1, S2, . . . SN (100) and to be buffered on a consistency server B (101) selected by hashing K and T together and taking the result modulo the size of the list of consistency servers (100) then using it as an index into that list, is requested by the application to be updated to some new value V, we can summarise the combined update method of the two referenced patents like so:

1. Inform consistency server B that the new value of record K of table T Is to be V

2. Inform all servers in S that the new value of record K of table T is to be V

And a summary of the combined read method of the two referenced patents is:

1. Ask the consistency server B if it has a value for record K of table T

2. If it replies with a successful result, return it, and this method is completed

3. Otherwise, consult some server Si from S to find the super-record containing record K of table T

4. For all records In the super-record, find the consistency server that is responsible for it, and inform that consistency server of the details of the record.

5. If the desired record is amongst those in the super-record, return it, and this method is completed.

6. Otherwise, return the sentinel value for a deleted record, to indicate that the record was deleted or never existed.

And a summary of the method for a server in S to handle a notification of a new value of a record using a write buffer is:

1. If there is a previous request in the write buffer to update the record K of table T to be some other value V′, and if so, replace it with the request to update it to V

2. If there is a later request in the write buffer to update the record K of table T to some other value V′, then since this request is older, discard it

And a summary of the method for a server in S to perform some writes from the write buffer is:

1. Take the most urgent update in the write buffer (e.g., oldest, or with the highest priority, or some other metric)

2. Find all other updates in the write buffer to records that fall within the same super-record as the record to be updated

3. Obtain the super-record in question from the storage system into memory; if it does not (yet) exist, then create an empty one in memory

4. Apply all the found updates to the super-record in memory, either updating existing records to their new values, or adding new records

5. Write the super-record from memory to the storage system (creating it in the storage system if it did not previously exist)

The first aspect of this invention is an elaboration of the above methods to perform the read and update operations, with reference to a set of application-specified mode indicators (sometimes implemented as Boolean flags) that modify the operations. The flags applicable to a read operation are CONSISTENT and ADJACENT_READS_LIKELY; the only flag applicable to a write operation is CONSISTENT.

The method for performing an update becomes:

1. If CONSISTENT, inform consistency server B that the new value of record K of table T is to be V

2. Inform all servers in S that the new value of record K of table T is to be V

The method for performing a read becomes:

1. If CONSISTENT, Ask the consistency server B if it has a value for record K of table T

2. If CONSISTENT, If it replies with a successful result, return it, and this method is completed

3. Otherwise, consult some server Si from S to find the super-record containing record K of table T

4. If ADJACENT_READS_LIKELY, For all records in the super-record, find the consistency server that is responsible for it, and inform that consistency server of the details of the record.

5. If the desired record is amongst those in the super-record, return it, and this method is completed.

6. Otherwise, return the sentinel value for a deleted record, to indicate that the record was deleted or never existed.

The application provides the CONSISTENT flag to read or update operations if it wishes to pay the increased latency cost of the consistency buffer algorithm, to obtain consistency. It is quite possible, and indeed sometimes even desirable, for the same data item to be read and updated with a mixture of CONSISTENT and non-CONSISTENT operations; consistency is unnecessary for bulk data imports and periodic snapshots for backup or offline-analysis purposes. Some part of a system that requires real-time access to a shared value may read and update it CONSISTENTly, while a part of the system that periodically samples it for statistical purposes might require low latency, and read it non-CONSISTENTly.

The application provides the ADJACENT_READS_LIKELY flag if it anticipates that the read will be followed by reads for this and other records in the same super-record in the near future. An application may normally have a very predictable access pattern, and therefore employ large super-records so that large numbers of records that will be required in quick succession are loaded in a single operation. However, other parts of the system may access records more randomly, in which case sending all the records within each of those large super-records to the consistency servers will simple increase the latency of those reads, and harm performance elsewhere in the system by loading the consistency servers with work, and pushing more worthy records out of their caches.

Another aspect of this invention is the use of an additional flag, GLOBAL, to update operations to control the checking for conflicting updates. The method of performing an update further becomes:

1. If the proposed update conflicts with locally-known information (e.g., if the client is also a server in the set S, and a conflict is detectable outright) then reject it, and this method is complete.

2. If the proposed update conflicts with information about the record known to the consistency server B (e.g., the update is an explicit record creation request, and B already has a record with the same primary key K in table T) then reject it outright, and this method is complete.

3. If GLOBAL, then:

4. Inform all servers in S of our intent to perform the update

5. When all available servers have responded, if any rejected the request, then take whatever steps are necessary to rescind the reservation, and reject the update, and this method is complete

6. Otherwise, proceed as usual

7. If CONSISTENT, inform consistency server B that the new value of record K of table T is to be V

8. Inform all servers in S that the new value of record K of table T is to be V

The corresponding methods for the servers to handle reservations are prior art, as alluded to above.

Applications may therefore request GLOBAL updates if they fear that other users of the database may issue conflicting updates. The GLOBAL flag need not be specified if the application knows that there is no way updates can be issued that will conflict, or if the cost of the occasional conflict is low compared to the cost of ensuring GLOBAL checking for conflicts (as low-cost conflict checking is performed even if GLOBAL is not specified). In particular, the GLOBAL flag may be gainfully omitted for initial bulk loads of the database, where the incoming data set is known to be free of conflicts and there are no other users of the database at the time.

Another aspect of this invention is the use of an additional flag, CONFIRMED, to update operations to control when the system reports success. The update method now becomes:

1. If the proposed update conflicts with locally-known information (e.g., if the client is also a server in the set S, and a conflict is detectable outright) then reject it, and this method is complete.

2. If the proposed update conflicts with information about the record known to the consistency server B (e.g., the update is an explicit record creation request, and B already has a record with the same primary key K in table T) then reject it outright, and this method is complete.

3. If GLOBAL, then:

4. Inform all servers in S of our intent to perform the update

5. When all available servers have responded, if any rejected the request, then take whatever steps are necessary to rescind the reservation, and reject the update, and this method is complete

6. Otherwise, proceed as usual

7. If CONSISTENT, inform consistency server B that the new value of record K of table T is to be V

8. If not CONFIRMED, Inform all servers in S that the new value of record K of table T Is to be V and informing no clients of success, and this method is complete

9. Otherwise, inform all servers in S that the new value of record K of table T is to be V and that this client would like confirmation of success

10. Wait until confirmation has been received from at least one server that is considered “non-local” to this client

Whether a server is considered “non-local” depends on the system configuration, which will contain some information that can be used to decide the set of servers considered local to a client; depending on the particular system, this may involve requiring the update to be confirmed from at least one server in a different geographical location to the client, or simply on a different physical computer to the client.

The request for confirmation of success is attached to the request as it is sent to the servers.

The method for inserting an update of record K of table T to some value V and information a set C of clients of success into the write queue then becomes:

1. If there is a previous request in the write buffer to update the record K of table T to be some other value V′ and to inform a set C′ of clients of success, and if so, replace it with the request to update it to V and to inform a set C+C′ (the union of the two sets) of clients of success 2. If there is a later request in the write buffer to update the record K of table T to some other value V′ and to inform a set C′ of clients of success, then since this request is older, discard it, but modify the existing request in the write buffer to Inform a set C+C′ of clients of success.

The method for performing writes from the write queue is extended to become:

1. Take the most urgent update in the write buffer (e.g., oldest, or with the highest priority, or some other metric)

2. Find all other updates in the write buffer to records that fall within the same super-record as the record to be updated

3. Obtain the super-record in question from the storage system into memory; if it does not (yet) exist, then create an empty one in memory

4. Apply all the found updates to the super-record in memory, either updating existing records to their new values, or adding new records

5. Write the super-record from memory to the storage system (creating it in the storage system if it did not previously exist)

6. For each of the updates, inform every client in the set of clients to be notified of success, that the update was completed.

### DESCRIPTION OF AN IMPLEMENTATION

The current implementation, known as “Data Store” (or “DS” hereafter) is a fully-replicated database embodying the inventions described in UK Patent Application 0920644.2 (System for Improved Record Consistency and Availability) and UK Patent Application 0920645.9 (A Method for Using Information About Application—Level Structural Access Patterns to Optimise Access to a Database).

On every server, an instance of our server component, known as the daemon, runs.

The DS provides an interface to applications as a set of C functions available from a shared library. The client application has to run on the same physical computer as the server, as the daemon applies changes from the write queue to an on-disk database, which the clients read from directly in order to reduce read latency.

Two client interface functions, GDSGet and GDSSet, perform the client read and update operations described above. The daemon listens to update and proposed-update messages received from clients, as well as other messages relating to aspects of the implementation beyond the scope of this document. The update messages are placed into a write queue as described in the method above. Proposed-update messages are handled by checking for conflicts in the database; if none are found, then the record is written into the database so that it will be found by subsequent proposed-update checks, but marked as being proposed so that read operations ignore it; proposals are not explicitly revoked by clients, as a failing client would then leave a dangling proposal, but are instead assigned an expiry time upon creation, and become invalid after expiry (there is no need to explicitly remove them from the database, but routine database operations that encounter expired proposals will remove them as they go).

The only form of update conflict rule implemented in the database schema itself is uniqueness of an indexed field. However, as well as the update flags documented above, additional update flags optionally add constraints to the individual updates. If the NO_OVERWRITE flag is specified, then the update will conflict with any other update to the same record, or an existing record; such updates can only create new records, never modify existing ones. If the NO_CREATE flag is specified, then the update will conflict with the absence of a previous update—if the record does not already exist, then this update will not create it; it will only modify an existing record. Since every client runs on the same physical computer as a server, the client's initial check for update conflict involves checking to see if the proposed update would cause a clash in any unique Indices, based on the database state known to the local server; and if the NO_OVERWRITE flag is set, then the presence of an existing record on disk or in the consistency buffer is considered grounds for rejecting the update; and if NO_CREATE is specified, then the absence of an existing record on disk or in the consistency buffer is likewise considered grounds for rejection.

1. A record storage system comprising;
two or more data stores, each data store comprising a record set that is substantially a replica of the record set stored by the or each other data store, a data store being designated as a primary data store to each record, and each record having record characteristics including a unique record identity, and
a first client configured to, in response to receiving a record update request comprising at least one write instruction, a data record identity identifying the data record on which the write instruction is to be performed, and a set of at least one or more mode indicators, request an operation on the identified record according to a record operation protocol, the record operation protocol being determined by the at least one mode indicator each time a record update request is received.

2. The record storage system of claim 1, the record update request comprising a ‘Global’ mode indicator, and the first client being configured to, when the ‘Global’ mode indicator is set, request an operation on the identified record according to the following protocol:
notifying all data stores of the intent to perform the operation on the record receive an indication from each data store as to whether the operation would be valid on the data store,
if all data stores have indicated that the operation would be valid, instructing all data stores to perform the operation on the record,
if not all the data stores have indicated that the operation would be valid, instructing all data stores to disregard the operation.

3. The record storage system of claim 2, the record update request comprising a ‘No Overwrite’ mode indicator, wherein, when the ‘No Overwrite’ mode indicator is set, the operation on the record of a data store is not valid if the data record identity matches an existing record in the data store.

4. The record storage system of any preceding claim, the record update request comprising a ‘No Create’ mode indicator, wherein, when the ‘No Create’ mode indicator is set, the operation on the record of a data store is not valid if the data record Identity does not match an existing record in the data store.

5. The record storage system of any preceding claim, the record update request comprising a ‘Consistent’ mode indicator, and the first client being configured to, when the ‘Consistent’ mode indicator is set, request an operation on the identified record according to the following protocol:
instruct the primary data store of the record to perform the operation on the record,
subsequent to the above step, instruct the other data stores to perform the operation on the record,

6. The record storage system of any preceding claim, the record update request comprising a ‘Confirmed’ mode indicator, and the first client being configured to, when the ‘Confirmed’ mode indicator is set, request an operation on the identified record according to the following protocol:
instruct each data stores to perform the operation on the record and subsequently receive a confirmation from the data store that the operation was successfully completed.

7. The record storage system of any preceding claim, further comprising;
a second client configured to, in response to receiving a record fetch request comprising a data record identity identifying the data record which is to be fetched, and a set of at least one request mode indicators, request the record according to the protocol determined by the at least one mode indicators.

8. The record storage system of any preceding claim, the record fetch request comprising a ‘Consistent’ mode indicator, and the second client being configured to, when the ‘Consistent’ mode indicator Is set, request the identified record according to the following protocol:
request for the record from the primary data store,
if the request for the record from the primary data store mode fails to complete due to an error or time out condition being reached, requesting the record from a data store other than the primary data store.

9. The record storage system of claim 8, the second client configured to, in response to receiving a record fetch request comprising characteristics of a desired record not including the desired record's unique identity and a set of at least one mode indicators including a ‘Consistent’ mode indicator, when the ‘Consistent’ mode indicator is set, request the record according to the following protocol:
requesting and receiving, from a data store other than the primary data store, a list of unique record identities of records matching the characteristics of the desired record,
requesting and receiving, from the primary data store, each of the records having a unique record identity from the received list of unique record identities,
determining the desired record by filtering all other records received from the primary data store that comprise a deleted record value or do not match the characteristics of the desired record.

10. A method of handling data in a record storage system comprising two or more data stores, each data store comprising a record set that is substantially a replica of the record set stored by each of the other data store(s), each record having one of the data stores as a primary data store, and each record having record characteristics including a unique record identity,
the method comprising the step of:
in response to receiving a record update request comprising at least one write instruction, a data record identity identifying the data record on which the write instruction is to be performed, and a set of at least one mode indicators, request an operation on the identified record according to a record operation protocol, the record operation protocol being determined by the at least one mode indicator each time a record update request is received.

11. A record storage system substantially as described with reference to and as shown in the accompanying figures.

12. A method of handling data in a record storage system substantially as described with reference to and as shown in the accompanying figures.
